(19) United States
(12) Patent Application Publication
(10) Pub. No.: US 2026/0319914 A1
(43) Pub. Date: Oct. 15, 2026

(54) Unit Test Generation AI Agent

(71) Applicant: Zscaler, Inc., San Jose, CA (US)

(72) Inventor: Claudionor Jose Nunes Coelho, JR., Redwood City, CA (US)

(73) Assignee: Zscaler, Inc., San Jose, CA (US)

(21) Appl. No.: 19/176,380

(22) Filed: Apr. 11, 2025

(51) Int. Cl. G06F 11/3604

(52) U.S. Cl. CPC G06F 11/3608

(57) ABSTRACT

A multi-agent AI-driven system addresses limitations of Large Language Models (LLMs) in automated software testing by integrating symbolic formal verification and generative AI. The system analyzes software to identify implied functions, dependencies, and static variables, generating mock-up compilation units to enable isolated unit testing. A symbolic verification engine systematically identifies backward arithmetic and logical conditions required to execute specific code paths, overcoming the inability of LLMs to reliably perform backward reasoning. LLMs then generate executable, forward-reasoned unit tests based on these formal results. Test executions produce coverage information that highlights gaps and detects errors or regressions. Reflective analysis by LLMs further generates targeted tests and suggests improvements, enhancing software robustness and test coverage. The method effectively combines formal logic with generative AI, enabling automated, reliable, and comprehensive software testing.

### FIELD OF THE DISCLOSURE

The present disclosure relates generally to computing, specifically artificial intelligence (AI). More particularly, the present disclosure relates to systems and methods for a unit test generation AI agent.

### BACKGROUND OF THE DISCLOSURE

Large Language Models (LLMs) are advanced AI models designed primarily for language generation tasks, such as summarization, translation, and text-based interaction. They have become integral components of applications including virtual assistants, chatbots, workflow automation, and scenario generation aimed at identifying emergent threats or exploit paths. Despite their versatility, LLMs face significant inherent limitations. One major challenge is their inability to perform backward reasoning tasks, particularly involving arithmetic operations or logical propositions. For instance, they typically struggle to systematically solve equations or reason backward through code logic to identify specific conditions required to trigger certain outcomes. This limitation arises because LLMs process information through forward propagation in neural network architectures, such as transformers, which inherently lack backtracking capabilities. Consequently, tasks like debugging software or systematically generating specific test cases based on backward arithmetic reasoning remain difficult or unreliable for LLMs. Furthermore, due to their probabilistic nature, LLMs can produce “hallucinations,” generating information that appears plausible yet is inaccurate. Lastly, their reliance on pre-training on extensive corpora restricts their knowledge to information available only up to their training cut-off date, making them unreliable for queries requiring more current knowledge.

### BRIEF SUMMARY OF THE DISCLOSURE

The present disclosure provides an AI-driven multi-agent system that addresses inherent limitations of LLMs in automated software testing, specifically their inability to systematically perform backward arithmetic and logical reasoning necessary for rigorous software verification. Conventional LLM-based methods fail at tasks such as reliably generating targeted test cases or debugging software because transformers within LLMs are inherently forward-propagating and incapable of backtracking to solve arithmetic or logical conditions. To overcome these challenges, the disclosed system integrates a symbolic formal verification engine with LLMs. First, it analyzes code to identify implied functions, dependencies, and static restrictions, automatically generating mock-up compilation units enabling isolated and controlled unit testing. Next, symbolic verification systematically identifies backward reasoning conditions to exercise specific code paths. LLMs then leverage these conditions to produce forward-generated executable unit tests. Finally, reflection via LLMs evaluates test outcomes, suggesting additional tests or modifications, thus ensuring robust, comprehensive testing, improved software reliability, and efficient regression detection.

### BRIEF DESCRIPTION OF THE DRAWINGS

The present disclosure is detailed through various drawings, where like components or steps are indicated by identical reference numbers for clarity and consistency.

FIG. 1 illustrates the transformer architecture commonly used in Large Language Models (LLMs).

FIG. 2 illustrates an AI-agent-based system highlighting the integration of LLMs with multiple external components to enhance their effectiveness and mitigate their inherent limitations.

FIG. 3 illustrates a detailed, automated software testing process that employs an integrated approach combining symbolic formal verification with LLMs in an AI-agent-driven framework, such as the AI-agent-based system.

FIG. 4 illustrates an example showing that packages in C are complicated to handle.

FIG. 5 illustrates an example of legacy code having no mockups.

FIG. 6 illustrates an example of unit test generation and coverage tests.

FIGS. 7 and 8 illustrate an example of unify databases and use unit test outputs as golden unit tests.

FIG. 9 illustrates a block diagram of a computing system, which may be used to implement various components in the present disclosure.

FIG. 10 illustrates a flowchart of a process automatically generating unit tests in an artificial intelligence (AI)-driven multi-agent software testing system.

### DETAILED DESCRIPTION OF THE DISCLOSURE

The present disclosure involves a multi-agent system designed to overcome inherent limitations of Large Language Models (LLMs) in software testing, particularly their inability to perform backward arithmetic reasoning. The solution integrates a symbolic formal verification engine with an LLM-based system. It operates in three main phases: (1) Implied Functions, where dependencies and code functions are analyzed to create mock-up compilation units, enabling direct and controlled testing; (2) Formal Engine, which uses symbolic verification techniques to systematically generate test cases that precisely target specific code execution paths by solving backward reasoning problems that LLMs cannot reliably handle; and (3) Reflection, wherein the LLM utilizes these formal results to generate forward-reasoning-based test code, verify correctness, identify runtime or compilation errors, and manage code coverage analysis. This hybrid approach ensures comprehensive and automated software testing that addresses both backward and forward reasoning requirements, significantly improving bug detection and coverage efficiency.

### Conventional LLM Limitations

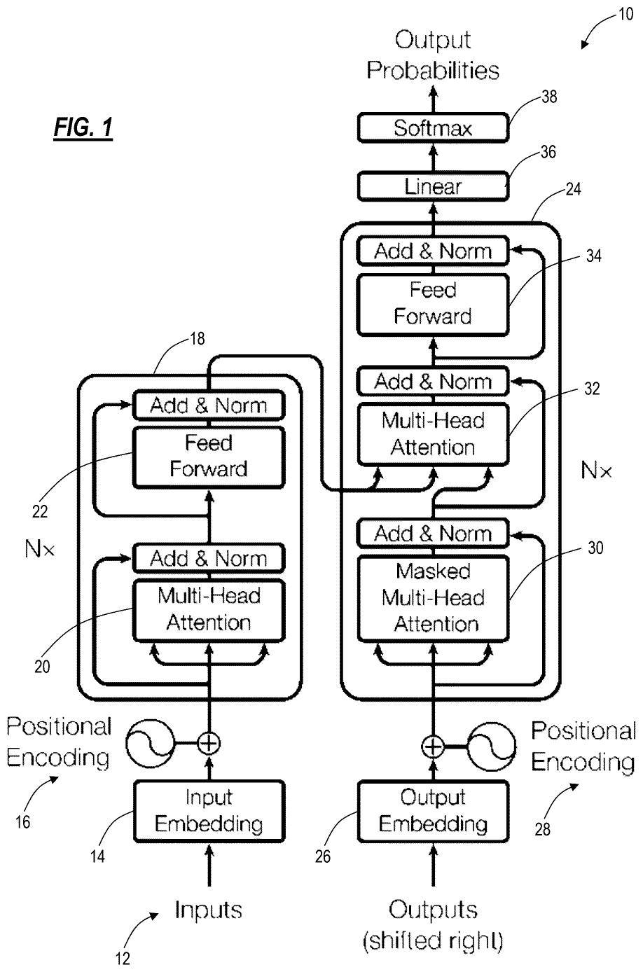

FIG. 1 illustrates the transformer architecture 10 commonly used in Large Language Models (LLMs). On the left side, the encoder component processes input text 12. Input words or tokens are first transformed into vector representations via an input embedding module 14, after which positional information (positional encoding 16) is added to retain the sequence order. An encoder 18 includes multiple layers (repeated N times), each including two main sub-layers: a multi-head self-attention mechanism 20, allowing the model to weigh and interpret tokens in relation to each other, and a feed-forward neural network 22, enhancing the representation power. Each sub-layer includes residual connections (“skip connections”) and layer normalization (“Add & Norm”) to maintain stable training and improve performance.

On the right side is a decoder component 24, responsible for generating output text. Like the encoder 18, it uses an embedding 26 and positional encoding 28 step. However, the decoder layers contain three distinct sub-layers: (1) a masked multi-head self-attention layer 30, which ensures the model attends only to previous tokens in the sequence, maintaining causality for text generation; (2) a multi-head attention layer 32 that interacts with the encoder outputs, effectively allowing the decoder to reference relevant parts of the input text; and (3) a feed-forward neural network layer 34, similar to that of the encoder. These layers also employ residual connections and layer normalization. The decoder output subsequently passes through a linear layer 36 and a softmax function 38, which converts the model's output into probabilities across a vocabulary, determining the next word or token in the generated text sequence.

This transformer architecture 10 enables LLMs to efficiently process textual data and perform various tasks, including language generation, summarization, and translation. They have become crucial components in practical applications such as virtual assistants (chatbots, workflow automation) and scenario generation tasks for identifying emergent threats and exploit paths.

However, despite their utility, LLMs present several notable challenges. Their pre-training requires enormous and static textual corpora, limiting their knowledge to information available only up to the cutoff date. Thus, queries about information emerging after this date typically yield unreliable or incorrect answers. Additionally, due to their inherently forward-directed processing structure, transformer-based models have significant limitations in logical reasoning tasks involving propositional clause backtracking or backward arithmetic reasoning. Moreover, the probabilistic nature of the token generation process often leads LLMs to “hallucinate,” producing seemingly plausible yet incorrect information.

Consider the following logical puzzle:

Given propositions:
p→q (p implies q)
q→r (q implies r)

Assume the condition that “r is false during the day” (¬r). If it is sunny now, what can we conclude?

Formally, we have: p→q→r r=¬day_sunny ¬p (p must be false)

Logically, if r is false, q must also be false, and consequently, p must be false. However, this straightforward reasoning breaks down when real-world context or factual knowledge is introduced. For instance, consider geographical context: the statement “it is sunny now” typically implies daytime. Yet, certain places—such as Stockholm during midsummer—experience sunlight even at night. Conventional LLMs, without explicit external world knowledge or context, often fail to reconcile such nuances. They cannot inherently determine that “sunny” doesn't universally imply daytime, thus confusing simple real-world logic puzzles.

Another practical example involving arithmetic reasoning is demonstrated by the following code snippet:

```
int run(int Age) {
  // ... (other code)
  Age++;
  // ... (other code)
  if ((Age * 10 + 1) == 1001) {
    do_something( );
  }
}
```

This example explains a scenario demonstrating why LLMs cannot reliably perform backward arithmetic reasoning in software debugging. In the given C code snippet, to trigger the do_something( ) function call, the condition (Age*10+1)==1001 must evaluate to true. This example points out the necessity of backward reasoning to solve for the value of Age. Specifically, it details the arithmetic steps backward from the target:

(Age*10+1)==1001 implies (Age*10)==1000, thus Age==100, but because the code increments (Age++) before checking, the initial value passed to run( ) must be 99.

This emphasizes that while this example is simple enough for some LLMs to guess correctly, generally, LLMs cannot systematically handle backward arithmetic reasoning required for reliably finding such bugs or test conditions.

In conclusion, conventional LLMs lack the systematic reasoning capabilities needed to effectively handle logical backtracking, backward arithmetic computations, and contextual nuance derived from real-world knowledge. Their probabilistic nature, limited numeric reasoning, and inability to reliably incorporate external facts severely limit their performance in tasks that demand rigorous logical inference or precise backward reasoning.

### AI Agents

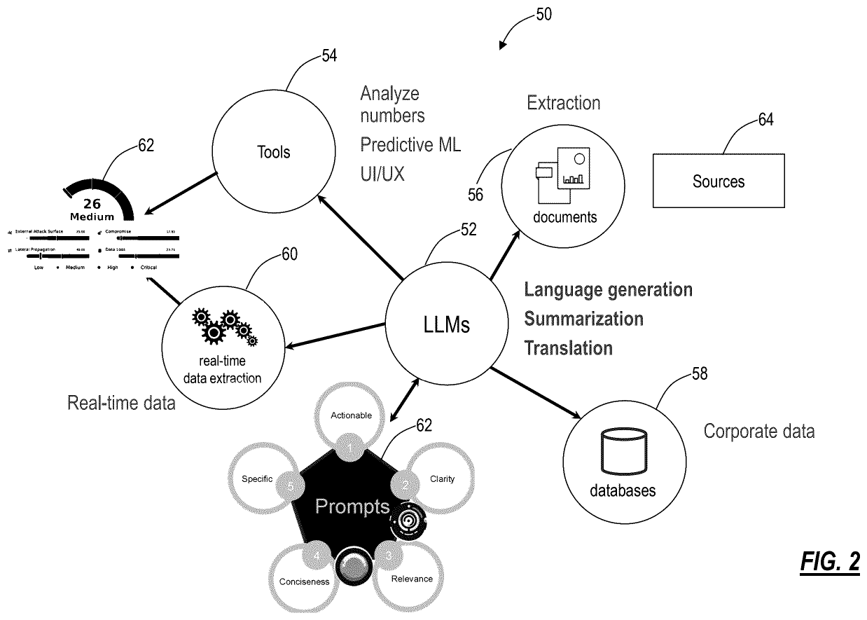

FIG. 2 illustrates an AI-agent-based system 50 highlighting the integration of LLMs 52 with multiple external components to enhance their effectiveness and mitigate their inherent limitations. At the core of the system 50 are the LLMs 52, responsible primarily for language generation, summarization, and translation tasks. Surrounding this central capability are several connected modules or resources that interact with the LLMs 50 to augment their functionalities. The connected modules or resources include tools 54, documents 56, databases 58, real-time data extraction 60, and a dashboard 62.

The tools 54 include analytic and predictive machine learning (ML) components, along with UI/UX support, via the dashboard 62, designed to interpret numerical data or predictive analytics outputs produced or enhanced by the LLMs 52. The documents 56 illustrates the use of LLMs 52 for document extraction, processing data from sources 64 like PDFs or structured reports, facilitating informed summarization and translation of complex documentation. The LLMs 52 connect with the databases 58 containing structured corporate data, which they query and synthesize, allowing for richer, contextually aware responses. The real-time data extraction 60 module provides timely data from dynamic, real-time sources (e.g., cybersecurity telemetry or live dashboards), enabling the AI-agent-based system 50 to respond effectively to current or emerging situations such as security threats. The prompts 62 underscore the importance of well-crafted prompts, characterized by five key elements: being actionable, clear, relevant, concise, and specific. Effective prompting directs the LLMs 52 to generate precise and useful outputs.

Together, this integrated architecture depicts a comprehensive multi-agent AI system 50 that leverages the strengths of LLMs 52 while addressing their limitations—particularly around logical reasoning and currency of information—by systematically integrating them with specialized analytic tools, structured and unstructured corporate data sources, and real-time data streams.

### Unit Test AI Agent

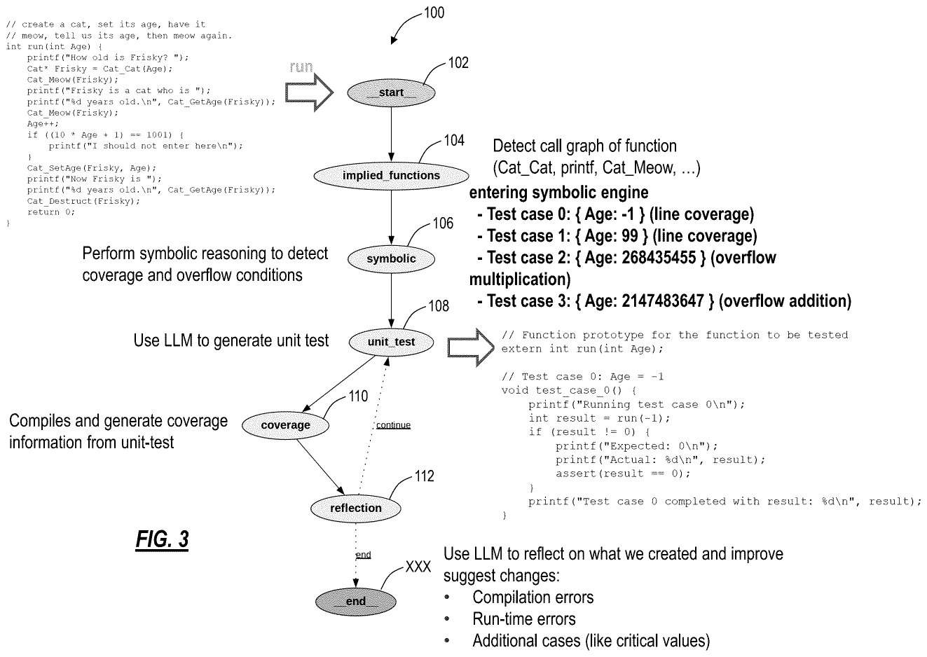

FIG. 3 illustrates a detailed, automated software testing process 100 integrating symbolic formal verification with Large Language Models (LLMs) in an AI-agent-based framework, such as AI-agent-based system 50. The process 100 may be implemented as a method comprising computer-implemented steps executed by one or more processors, provided through a cloud-based or Software-as-a-Service (SaaS) platform configured to carry out these steps, or embodied within a non-transitory computer-readable storage medium storing executable instructions that, when executed by one or more processors, perform the steps described herein. The software testing process 100 is designed specifically to overcome the intrinsic limitations of LLMs, especially their inability to systematically perform backward arithmetic reasoning, propositional clause backtracking, or reliably detect software bugs.

The software testing process 100 includes:
(1) Execution Start (__start__): (step 102). Initially, the process 100 begins by targeting a specific software function for testing—in this example, the run(int Age) function within a code snippet involving operations on a hypothetical object “Cat.”
(2) Implied Functions: (step 104). This step 104 performs static code analysis to detect the call graph, which identifies all external functions and static variables that the targeted code interacts with. The analysis involves extracting information such as dependencies on functions (Cat_Cat, printf, Cat_Meow) and variables required for accurate, isolated unit testing. A critical task here is the generation of mock-up compilation units (“mockups”). These mockups remove access restrictions, particularly the “static” modifiers on variables and functions, to allow isolated unit tests to directly access and manipulate these previously inaccessible entities. This allows the testing of legacy or tightly-coupled codebases not originally written for modular testing.
(3) Symbolic Reasoning: (step 106). Next, a formal symbolic verification engine systematically performs symbolic reasoning, identifying precise conditions required to exercise specific code paths. It generates sensitization conditions (“backward reasoning”) that guarantee coverage of specific lines, branches, or conditions within the code under test. In an example embodiment, the formal symbolic verification engine can be Efficient SMT-Based Model Checker (ESBMC) which is a software verification tool that uses Satisfiability Modulo Theories (SMT) solvers to verify the correctness of software programs, particularly for detecting runtime errors, assertion violations, or verifying properties specified within the program. ESBMC typically analyzes programs written in languages like C or C++ and systematically explores their state space to ensure compliance with specified behaviors or safety requirements.

For example, the symbolic engine might determine that to cover a line involving arithmetic comparison ((Age*10+1)==1001), the variable Age must be set specifically to 99. Additionally, the symbolic engine identifies extreme or boundary conditions capable of triggering overflow conditions, such as setting Age to very large values (268435455, 2147483647). These conditions expose potential vulnerabilities like integer overflow or boundary checking flaws. This step 106 is particularly crucial because LLMs are unable to reliably perform backward arithmetic or logical reasoning. Hence, the symbolic engine provides explicit backward-reasoned conditions, eliminating the guesswork inherent in using standalone LLMs for such tasks. (
4) Unit Test Generation via LLM: (step 108). The process 100 then leverages the forward reasoning capability of LLMs to create executable test cases based on symbolic reasoning output. For each symbolic condition provided (e.g., Age=−1, 99, or large overflow integers), the LLM automatically generates structured, human-readable, executable code to test these conditions systematically.

The generated test cases explicitly:
Set input values (as dictated by the symbolic engine).
Run the target function (run) under these conditions.
Evaluate and assert expected outputs or behaviors.
Include diagnostic information via standard output (e.g., printing “Expected,” “Actual,” and “Test completed” status).
(5) Coverage Collection: (step 110). After generating the unit tests, the testing process 100 compiles and executes the tests against the mock-up compilation units. During execution, a coverage analyzer systematically tracks the lines, branches, or statements that each test case exercises. The output is structured to show precisely how often each code segment is reached during tests, clearly highlighting well-tested versus poorly tested areas of the software.
(6) Reflection via LLM: (step 112). The final stage, “reflection,” uses the capabilities of LLMs for evaluating and interpreting results from previous steps. The LLM:
Reviews the compiled and executed test outcomes.
Identifies specific issues like:
   Compilation errors (syntax issues, missing dependencies).
   Runtime errors (segmentation faults, memory leaks, crashes).
   Logical errors or uncovered cases (e.g., boundary conditions or overlooked critical scenarios).
Suggests concrete improvements:
   Generation of additional, targeted test cases.
   Adjustments to the mock-up compilation units.
   Modifications of existing tests to improve coverage or robustness.

Reflection significantly improves the overall quality and completeness of the test suite, incorporating iterative improvements based on empirical results, and ensuring the system adapts dynamically to new findings.

This integrated approach addresses key limitations highlighted earlier in the transcript:
(1) Backward Reasoning Limitations: Symbolic verification directly solves backward arithmetic and logical reasoning problems that pure LLM-based methods cannot handle reliably.
(2) Legacy and Non-Modular Code Testing: The automatic creation of mock-ups addresses a common challenge in software engineering—isolating legacy or tightly coupled code for modular testing.
(3) Integration of Formal and Generative AI: Uniquely combines symbolic verification (formal logic) and generative models (LLMs) within a multi-agent framework, complementing the strengths of each method and offsetting their weaknesses.
(4) Automated, Reflective Testing: Provides a structured yet dynamic process that leverages iterative feedback and refinement, systematically enhancing the robustness, coverage, and effectiveness of automated software testing.

In conclusion, the described multi-agent AI-agent system 50 provides a comprehensive and powerful approach to software testing, leveraging both formal symbolic reasoning and generative LLM capabilities to achieve robust, reliable, and automated test generation and execution.

### Legacy Code

Many legacy systems are not “test-friendly,” often depending heavily on external services, hardware, or modules without clear separation. Automatic mockups address these issues by:
(1) Providing Isolation: External dependencies are replaced with deterministic mock objects, enabling repeatable, predictable tests.
(2) Improving Testability: Edge cases and error conditions become easier to verify because any external calls are within the test environment's control.
(3) Accelerating Test Creation: Without having to hand-code all of the stubs or mocks, developers save significant effort—critical when modernizing large, older codebases.
(4) Enhancing Reliability: A stable set of mocks and tests ensures consistent regression checks as the code evolves.

### Example

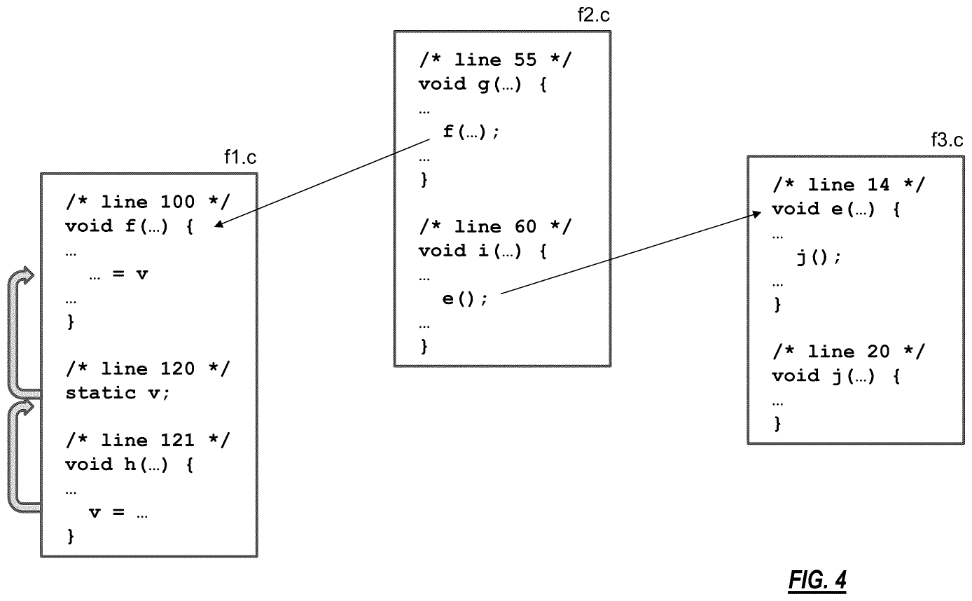

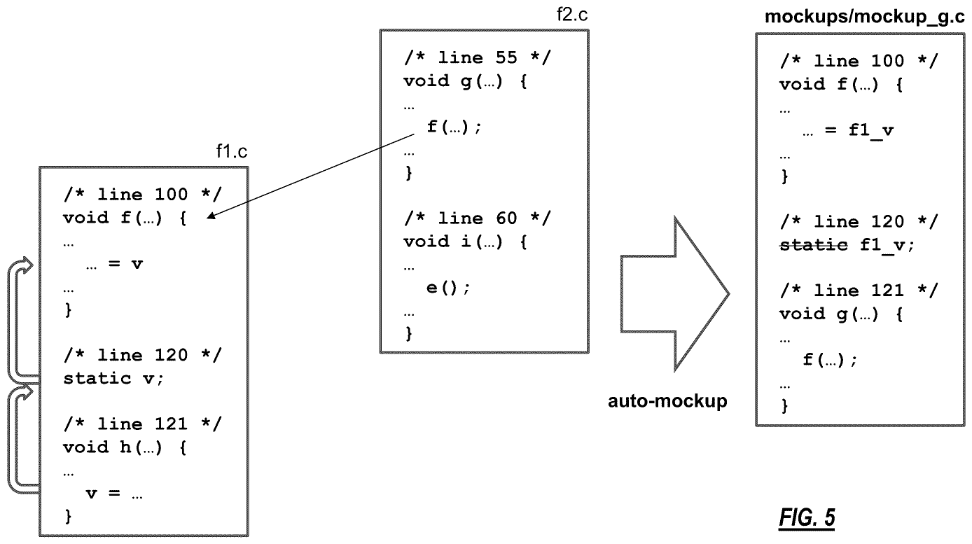

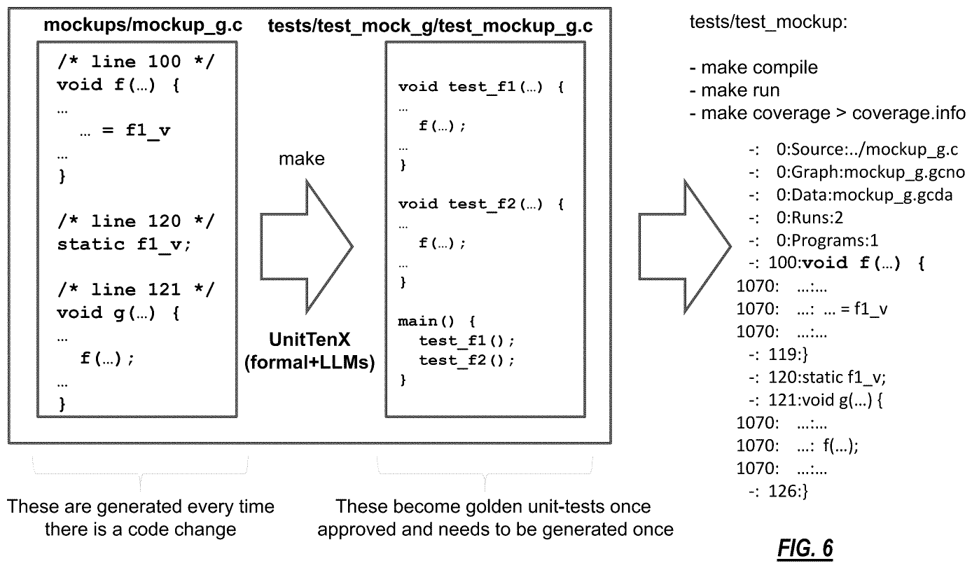

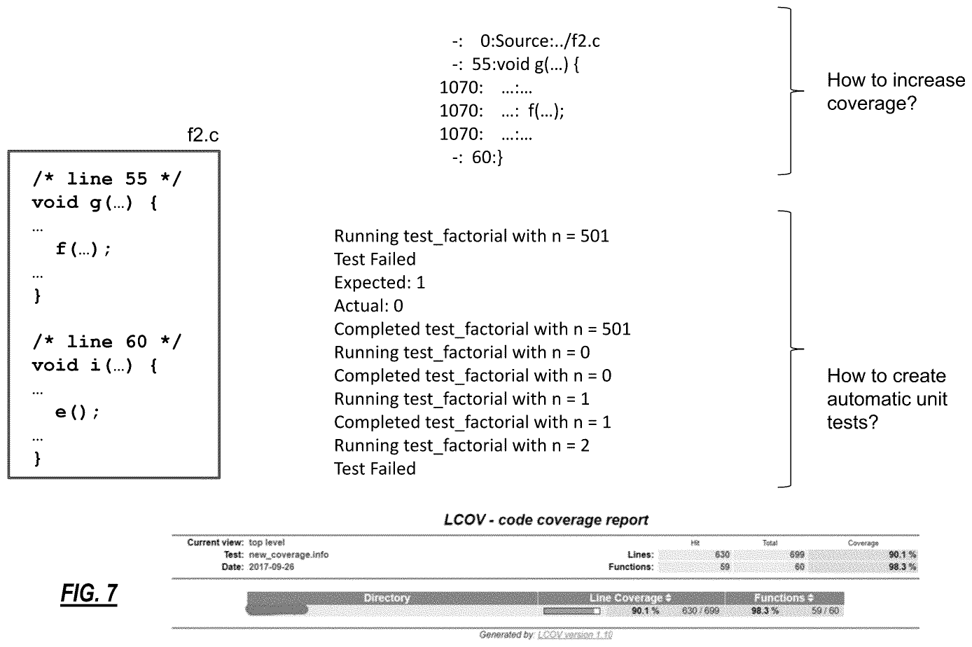

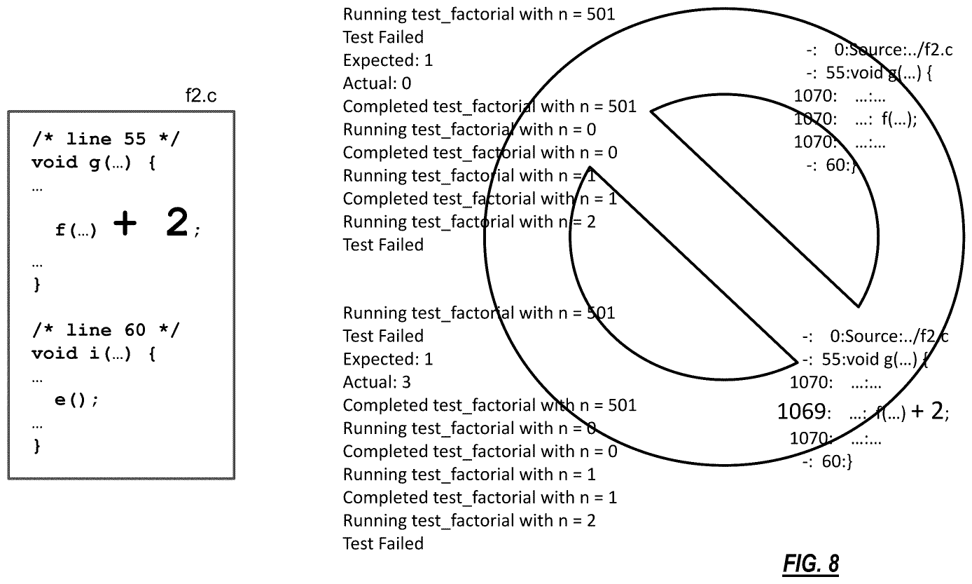

FIG. 4 illustrates an example showing that packages in C are complicated to handle. FIG. 5 illustrates an example of legacy code having no mockups. FIG. 6 illustrates an example of unit test generation and coverage tests. FIGS. 7 and 8 illustrate an example of unify databases and use unit test outputs as golden unit tests.
FIG. 4 illustrates a typical complexity encountered when dealing with software packages written in the C programming language, especially when performing automated testing or analysis, as discussed in the transcript. FIG. 4 shows three separate source files (f1.c, f2.c, and f3.c), each containing multiple functions and variable definitions. The complexity arises due to the dependencies across these files:
   (1) In the file f2.c, the function g( ) calls another function f( ) defined in a different file (f1.c). Similarly, within f2.c, the function i( ) calls the function e( ), which resides in yet another file (f3.c).
(2) In the file f3.c, the function e( ) further calls another local function, j( ), creating an additional internal dependency.
(3) The file f1.c defines function f( ), which accesses a variable v. This variable v is defined as static at line 120, meaning its scope is intentionally limited to the file f1.c, restricting direct external access. Additionally, a separate function h( ) in f1.c also accesses and modifies this static variable v, further complicating testing and integration.

These types of dependencies are typical in legacy or complex software projects. Such static declarations prevent straightforward external access or testing, making isolated unit tests challenging. To overcome these difficulties, the solution involves creating automated mock-up compilation units—essentially aggregating all necessary components, removing restrictive static modifiers, and enabling comprehensive testing in isolated, controlled environments. The depicted scenario demonstrates precisely why automated analysis, symbolic reasoning, and structured mock-up generation are critical for effective automated testing and verification of legacy or tightly coupled codebases.

FIG. 5 demonstrates the process of creating auto-generated mockups to facilitate automated software testing, especially for legacy or complex codebases, as discussed in the transcript. On the left side, the original legacy code is represented by two C source files, f1.c and f2.c. The files contain multiple functions and static variables, creating complicated interdependencies that are not easily testable in isolation:
(1) The file f1.c defines the function f( ), which internally accesses a static variable v. This variable (v) is defined as static, limiting its visibility exclusively to the f1.c file. The presence of static variables makes direct testing or manipulation from external tests challenging.
(2) The file f2.c contains the function g( ), which calls the function f( ) defined externally in f1.c. This inter-file dependency further complicates isolated testing scenarios.

To overcome this complexity, FIG. 5 illustrates the concept of automatically creating a mock-up compilation unit, shown on the right side as mockups/mockup_g.c. The mock-up compilation unit is generated automatically (“auto-mockup”) by the multi-agent AI system and resolves testing complications by:
(1) Removing the static attribute from previously static variables, converting them into externally accessible global variables (e.g., transforming static v; into f1_v;). This adjustment allows the testing code direct manipulation and verification of these previously inaccessible variables.
(2) Aggregating relevant functions from multiple files into a single compilation unit. For example, the function g( ) from f2.c and the function f( ) from f1.c are consolidated into the single auto-generated mockup unit.

This auto-mockup approach provides a crucial advantage in automated testing by simplifying code dependencies and enabling direct, isolated, and controlled testing of functions that would otherwise be difficult or impossible to test in their original legacy state.

FIG. 6 illustrates the detailed workflow for generating automated unit tests and collecting code coverage information based on mock-up compilation units, as discussed in the provided transcript. The workflow includes three key stages:
(1) Mockup Compilation Units. On the left, FIG. 6 presents an auto-generated mock-up compilation unit (mockups/mockup_g.c) created automatically by the multi-agent system. This mockup consolidates necessary code components from legacy or complex source files, modifying them to facilitate direct testing:
(A) Functions from various original files are aggregated.
(B) Static variables, previously inaccessible externally, are converted into global variables (e.g., changing static v to f1_v), allowing direct manipulation within tests.
(C) Such mockups are regenerated automatically whenever there is a code change, ensuring that the testing always targets the most up-to-date software state.
(2) Generation of Unit Tests using Formal Methods and LLMs (“UnitTenX”). In the middle panel of FIG. 6 (tests/test_mock_g/test_mockup_g.c), the multi-agent system (UnitTenX, combining formal symbolic verification with LLMs) generates structured and executable unit tests. These tests are designed explicitly to exercise the mockup code thoroughly and reliably:
(A) Each test function (test_f1( ), test_f2( ), etc.) sets specific conditions (based on symbolic analysis) to systematically verify different code paths or conditions.
(B) A main( ) function orchestrates the execution of these individual test cases, ensuring comprehensive coverage.
(C) Once reviewed and approved, these unit tests become “golden tests,” meaning they're stable, reliable references that typically require only one-time generation, reducing maintenance overhead.
(3) Coverage Information Collection. On the right side of FIG. 6, the results of running these tests are demonstrated. The system executes three steps (make compile, make run, make coverage) to produce comprehensive coverage information:
(A) The coverage output (coverage. info) indicates precisely which code lines in the mockup have been executed during testing and how frequently.
(B) Coverage data provides visibility into tested and untested code segments, helping identify areas that may require additional test coverage or further scrutiny.

Together, these stages form an automated, integrated workflow enabling thorough testing and verification of legacy or complex software, overcoming traditional limitations through a combination of mockup compilation, formal symbolic reasoning, and LLM-driven test generation.

FIG. 7 demonstrates the integration and use of unified databases and the outputs of generated unit tests as “golden” reference tests to enhance software quality, based on the discussion from the transcript. Specifically, FIG. 7 depicts:
(1) Code Coverage Information. On the upper-right side, FIG. 7 illustrates the output of code coverage information, indicating precisely which parts of the source code (f2.c) are being exercised during testing. For example, it lists line 55 (void g( . . . )) and line 60, along with references to internal calls (e.g., f( . . .) ). This clearly identifies gaps in testing coverage, providing valuable insights into which code paths are untested or insufficiently tested. This prompts the question: “How to increase coverage?” which directly addresses the need to create additional, targeted tests.
(2) Unit Test Output as Golden Reference. Below the coverage information, FIG. 7 provides example outputs from automated unit tests (in green). These outputs explicitly show the results of running multiple tests—for example, testing a factorial function with various input values (n=501, 0, 1, 2). It clearly identifies scenarios where tests pass (“Completed test_factorial”) or fail (highlighting mismatches in expected versus actual results, e.g., Test Failed, Expected: 1, Actual: 0). Such outputs form the basis for creating stable, repeatable “golden unit tests,” enabling future regression testing and verification. This directly raises the second critical question: “How to create automatic unit tests?” suggesting that automated generation of these unit tests, driven by formal methods and AI-agent frameworks, is essential for efficient software testing.
(3) Aggregated Code Coverage ReportingAt the bottom of the figure, an example of an aggregated code coverage report (LCOV—code coverage report) is provided. It summarizes testing effectiveness across multiple files or functions, clearly illustrating the percentage of code coverage achieved (90.1% line coverage, 98.3% function coverage), thus providing a high-level overview of software test quality.

Overall, FIG. 7 highlights how integrating databases of coverage information and systematically generated automated test results can enhance software reliability by:
(A) Identifying and closing coverage gaps,
(B) Automating rigorous, repeatable unit test generation, and
(C) Providing stable, authoritative (“golden”) tests to ensure ongoing software quality.

FIG. 8 illustrates the role of using unit-test outputs as golden references for regression testing, specifically highlighting the system's capability to detect unintended code changes and regressions, as described in the transcript. In the center-left of FIG. 8, a modification to the original source code (f2.c) is depicted by the addition of an unintended change (adding “+2” to the call f( . . . )). This change symbolizes an inadvertent error or regression introduced during software modification.

On the right side, FIG. 8 shows the unit-test execution outputs, demonstrating how previously established golden unit tests immediately detect the regression:
(1) Before the change (upper green output), certain tests already fail, highlighting expected versus actual outcomes. These original outputs are considered stable “golden” tests, representing the correct, previously validated behavior.
(2) After the unintended code change (lower green output), additional differences emerge clearly. In particular, a specific failure (Actual: 3) directly corresponds to the introduced “+2” error in the source code.

The presence of a large, red “prohibited” symbol reinforces that this unintended modification is undesirable and easily caught by the automated test and verification system. FIG. 8 effectively demonstrates how the described approach—integrating databases of test results, using generated mockups, symbolic reasoning, and automated test generation—enables the rapid detection of regressions or unintended code changes, significantly improving software reliability and maintainability.

### Operating Environment

In an embodiment, the technical environment requirements for implementing the multi-agent system 50 and the process 100 relies on integration of several distinct components rather than simply leveraging LLMs alone.

For example, key aspects of the environment can include, in one embodiment:
(1) AzureOpenAI: The solution utilizes Microsoft's AzureOpenAI services to provide access to powerful, cloud-hosted LLM capabilities. AzureOpenAI offers a scalable infrastructure for tasks involving language generation, summarization, and translation.
(2) Multi-agent system architecture: The solution is not an LLM-only approach or purely a prompt engineering problem. Instead, it represents a sophisticated, multi-agent architecture integrating symbolic reasoning (formal verification tools) with generative LLMs. Two of the workflow's critical components are based on LLMs, whereas other essential tasks depend on specialized symbolic reasoning tools.
(3) ESBMC (Efficient SMT-Based Bounded Model Checker): The ESBMC tool provides symbolic reasoning and formal verification capabilities essential to the multi-agent approach. ESBMC is an open-source, context-bounded model checker based on satisfiability modulo theories (SMT) designed specifically for verifying single-threaded and multi-threaded C/C++ programs. It supports verification of various correctness properties, such as detecting overflow conditions, boundary checks, and logical errors, and does not require explicit program annotations, though it supports them for added verification capabilities.
(4) x86_64 Linux Environment: To effectively compile and run ESBMC, the solution specifies the need for a standard x86_64 Linux-based computing environment. This requirement ensures compatibility, stability, and optimal performance of symbolic verification tasks.

The combination of AzureOpenAI (for language generation and analysis), ESBMC (for rigorous symbolic reasoning), and a suitable Linux computing environment forms the technical backbone for this multi-agent AI-driven software testing solution. This approach effectively leverages the strengths of each technology component, ensuring robust, accurate, and efficient automated software testing.

### Example Computing System Architecture and Cloud Deployment

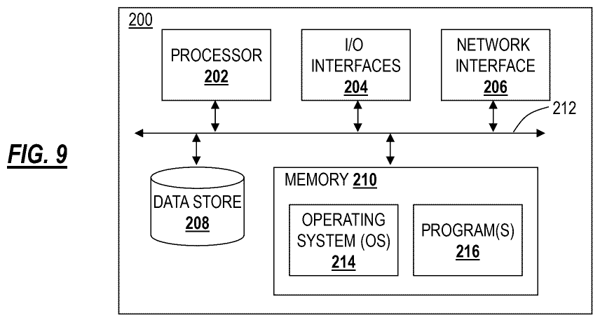

FIG. 9 illustrates a block diagram of a computing system 200, which may be used to implement various components in the present disclosure. The computing system 200 can be implemented in many ways, including laptops, desktops, smartphones, tablets, physical servers, clusters of machines, virtual machines (VMs) running on hypervisors, or serverless computing frameworks. Regardless of the underlying infrastructure, the computing system 200 typically includes one or more processors 202, input/output (I/O) interfaces 204, a network interface 206, a data store 208, and memory 210.

It should be noted that FIG. 9 presents a simplified view; in practice, the computing system 200 may feature additional hardware and software. These components 202, 204, 206, 208, 210 are coupled via a local interface 212, which may include various wired or wireless buses, high-speed interconnects, or switching fabrics. The local interface 212 can also include controllers, buffers, caches, drivers, repeaters, and receivers, along with addressing and control lines to promote efficient communication and resource sharing among components.

Each processor 202 is a hardware element—such as a central processing unit (CPU), multicore processor, system-on-chip (SoC), graphical processing unit (GPU), or a processing element in a larger compute cluster—designed to execute software instructions. These processors may be general-purpose or specialized, selected based on performance, power efficiency, or workload needs. During operation, each processor 202 retrieves and executes instructions stored in memory 210, coordinates data exchanges with the data store 208, and manages overall system 200 activities. In large-scale environments, multiple processors 202 can be used in parallel computing architectures to handle elevated traffic and complex workloads efficiently.

The I/O interfaces 204 allow the computing system 200 to interact with external peripherals, enabling both user input (e.g., via keyboards, touchscreens, or sensors) and system output (e.g., to displays or printers). Depending on the application, these I/O interfaces 204 can also support specialized devices for maintenance, debugging, or other administrative functions. Meanwhile, the network interface 206 handles connectivity to external networks, which may include the Internet, private corporate networks, or cloud environments. This network interface can be based on Ethernet, Wireless LAN, 5G, or a virtualized cloud interface. By relying on secure transport protocols and encryption, data transmitted via the network interface 206 can remain protected, enabling the computing system 200 to participate in distributed or cloud-based deployments.

The data store 208 provides storage for both persistent and temporary data. This storage may utilize volatile memory (e.g., RAM) for transient, high-speed operations or nonvolatile media (e.g., solid-state drives, hard disk drives, optical media) for durable, long-term retention. In some deployments, the data store 208 may be integrated with network-attached storage (NAS), storage area networks (SAN), or cloud-based storage solutions. These configurations can scale from modest local setups to enterprise-level installations, potentially offering features such as global deduplication, compression, encryption at rest, and multi-site replication. The data store 208 may hold operational logs, configuration details, policy rules, program binaries, and cached computation results.

The memory 210 is the primary working memory for the processors 202, often composed of volatile elements like DRAM (e.g., DDR, SDRAM) for speed, though it may also include nonvolatile components such as Flash memory or NVRAM. Memory 210 can be distributed across nodes or servers, supporting large-scale in-memory processing demanded by modern cloud services. Typically, the memory 210 stores the operating system (O/S) 214 and one or more programs 216. The O/S 214 handles core system tasks such as process scheduling, memory allocation, file management, and networking.

For SaaS or cloud components, the computing system 200 can be deployed as a private cloud in a single organization's datacenter, a public cloud hosted by a third-party provider, or a hybrid cloud combining elements of both for specific security, performance, or compliance considerations. Cloud computing abstracts physical hardware—servers, storage devices, network components—into on-demand, scalable resources. This enables organizations to provision computing power, storage, and network bandwidth with minimal upfront expenses, adapting to fluctuating workload demands.

According to the U.S. National Institute of Standards and Technology (NIST), cloud computing is “a model for enabling convenient, on-demand network access to a shared pool of configurable computing resources (e.g., networks, servers, storage, applications, and services) that can be rapidly provisioned and released with minimal management effort or service provider interaction.” Unlike traditional client-server environments, cloud computing typically delivers applications via a web interface, reducing the need for local installations and updates. Centralizing the hosting of applications allows providers to uniformly release new features, apply security patches, and manage licensing. These cloud-based models, often referred to as “Software as a Service” (SaaS), allow end users to access the software through browsers or lightweight client applications, benefiting from continuous improvements and frequent updates.

Various embodiments may rely on different forms of processing circuitry—general-purpose microprocessors, CPUs, network processors, GPUs, field programmable gate arrays (FPGAs), programmable logic devices (PLDs), or similar. This circuitry may be controlled by software, firmware, or a combination thereof, possibly in combination with non-processor circuits, to accomplish the functionalities outlined here. Alternatively, specific tasks may be implemented by state machines or one or more ASICs (application-specific integrated circuits), each addressing certain functions through dedicated logic. In some cases, a hybrid approach that merges these strategies may be adopted. Moreover, implementations can include a non-transitory computer-readable storage medium that holds computer-readable instructions. When executed by a device containing suitable processing circuitry, these instructions drive the system to perform the disclosed methods or algorithms. Examples of non-transitory storage media include hard disks, optical disks, magnetic devices, read-only memory (ROM), programmable ROM (PROM), erasable PROM (EPROM), electrically erasable PROM (EEPROM), flash memory, or other forms of persistent/semi-persistent storage. Once stored, the executable instructions enable the system to fulfill the methods detailed in this disclosure.

### Process

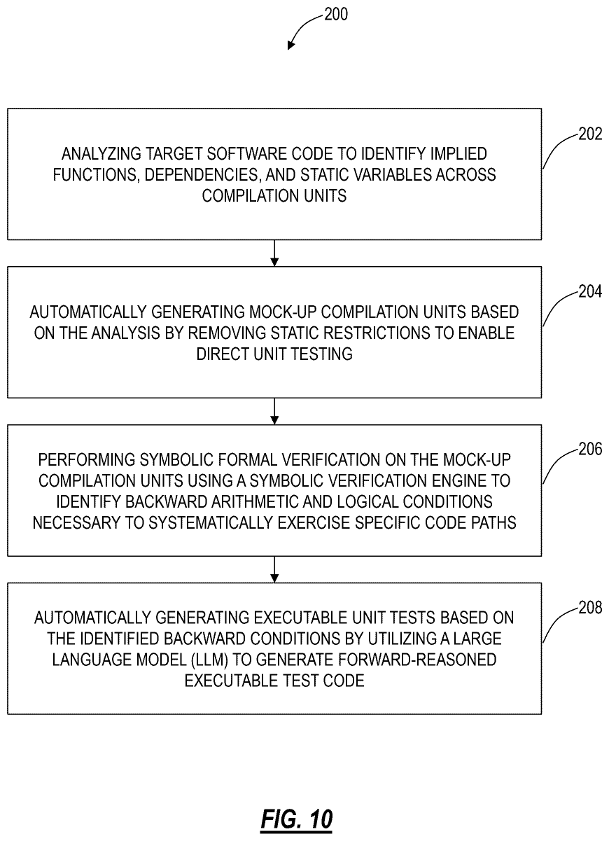

FIG. 10 illustrates a flowchart of a process 200 automatically generating unit tests in an artificial intelligence (AI)-driven multi-agent software testing system. The process 200 may be implemented as a method comprising computer-implemented steps executed by one or more processors, provided through a cloud-based or SaaS platform configured to carry out these steps, or embodied within a non-transitory computer-readable storage medium storing executable instructions that, when executed by one or more processors, perform the steps described herein.

The process 200 includes analyzing target software code to identify implied functions, dependencies, and static variables across compilation units (step 202); automatically generating mock-up compilation units based on the analysis by removing static restrictions to enable direct unit testing (step 204); performing symbolic formal verification on the mock-up compilation units using a symbolic verification engine to identify backward arithmetic and logical conditions necessary to systematically exercise specific code paths (step 206); and automatically generating executable unit tests based on the identified backward conditions by utilizing a large language model (LLM) to generate forward-reasoned executable test code (step 208).

The process 200 can further include executing the generated unit tests; and collecting code coverage information resulting from execution. The process 200 can further include evaluating test execution results and code coverage information produced by executing the generated unit tests; identifying runtime errors, logical errors, compilation errors, or insufficiently tested code paths based on the evaluation; and automatically generating, using the LLM, additional targeted unit tests or suggesting adjustments to existing mock-up compilation units to enhance overall code coverage and address identified errors or coverage gaps. The process 200 can further include automatically identifying and correcting unintended regressions introduced during software modification by comparing unit test outputs against previously established golden unit-test results. The evaluating the test execution results can include analyzing detailed diagnostic outputs from executed unit tests indicating expected versus actual results.

The symbolic formal verification can include employing an Efficient SMT-Based Model Checker (ESBMC). The ESBMC analyzes the mock-up compilation units for runtime errors, integer overflow conditions, and boundary checking violations. The process 200 can further include using cloud infrastructure to host and operate the large language model. The generating mock-up compilation units can include consolidating functions and previously static variables from multiple original source files into a single compilation unit; and automatically converting static variables into externally accessible global variables. The process 200 can further include aggregating the generated unit test results in a database to provide unified coverage reports highlighting tested and untested code segments. The aggregated database of unit test results can be used as a golden reference for future regression testing.

The mock-up compilation units and unit tests can be automatically regenerated upon each software code change to ensure continuous testing accuracy and regression detection. The symbolic verification engine can explicitly generate sensitization conditions capable of triggering integer overflow and boundary conditions to systematically expose vulnerabilities. The process 200 can further include performing automated real-time data extraction and integrating real-time data sources with the large language model to ensure contextually relevant test scenario generation. The process 200 can be executed via one or more processors configured within a Software-as-a-Service (SaaS) or cloud-based computing infrastructure.

### SUMMARY

The present disclosure describes a multi-agent AI-driven software testing system that uniquely integrates symbolic formal verification with generative LLMs to overcome significant limitations associated with conventional AI-based testing approaches. Conventionally, LLMs have fundamental limitations in tasks requiring backward arithmetic reasoning, propositional clause backtracking, and systematic debugging, due to their forward-only transformer architecture. The disclosed system addresses these limitations through an innovative combination of:
(1) Symbolic Formal Verification: A symbolic verification engine, such as ESBMC, systematically identifies conditions required to trigger specific code paths through backward reasoning, resolving computationally complex problems that traditional LLMs inherently cannot reliably handle.
(2) Automated Mock-up Generation: The solution automatically creates mock-up compilation units that remove restrictions like static variables, thus enabling isolated and direct unit testing of legacy or tightly-coupled code. This approach significantly simplifies testing previously untestable or difficult-to-test code segments.
(3) Reflective Test Enhancement: Using generative AI in a reflective mode, the system evaluates test coverage and execution results, identifies errors or coverage gaps, and automatically generates additional targeted tests or corrective actions, continuously improving test effectiveness and software quality.

The disclosed approach is novel in its integration of symbolic formal reasoning with generative LLM technology within a unified AI-agent-driven architecture. Specifically, the disclosed approach includes:
(1) A hybrid, multi-agent architecture specifically designed to leverage symbolic backward reasoning combined with forward-driven generative AI test code creation.
(2) Automatic mock-up compilation units generation enabling direct manipulation and testing of software components previously inaccessible due to static encapsulation.
(3) Automatic reflective analysis by LLMs to iteratively refine test suites, further enhancing test coverage, reliability, and accuracy.

The disclosed approach provides significant technical benefits, including:
(1) Enhanced Reasoning Capabilities: By integrating symbolic verification, the solution reliably handles backward arithmetic and logical reasoning tasks, significantly surpassing capabilities of traditional LLM-only methods.
(2) Improved Testing of Legacy Code: Automated mock-up units simplify the testing of legacy and tightly coupled software by converting static variables and functions into accessible units, dramatically improving modularity, maintainability, and testability.
(3) Automated Iterative Improvement: Reflective AI-driven adjustments ensure continuous enhancement of test suites, addressing both newly introduced regressions and persistent coverage gaps, significantly increasing software robustness.

Finally, The integrated AI-agent system disclosed herein provides clear, measurable advantages over traditional and standalone AI-driven testing methods:
(1) Robustness and Reliability: The combination of symbolic logic verification and generative AI substantially reduces the risk of undetected software bugs and regressions.
(2) Efficiency and Automation: Automating previously manual, complex tasks—such as mock-up generation and targeted test-case creation—greatly accelerates the software testing lifecycle.
(3) Comprehensive Coverage: Systematically identifying all relevant code paths and boundary conditions ensures thorough testing coverage, dramatically reducing software vulnerabilities and failure risks.
(4) Continuous Adaptation: Reflective mechanisms enable continuous refinement of testing methodologies, adapting dynamically to evolving codebases and new testing insights.

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A method for automatically generating unit tests in an artificial intelligence (AI)-driven multi-agent software testing system, comprising:
analyzing target software code to identify implied functions, dependencies, and static variables across compilation units;
automatically generating mock-up compilation units based on the analysis by removing static restrictions to enable direct unit testing;
performing symbolic formal verification on the mock-up compilation units using a symbolic verification engine to identify backward arithmetic and logical conditions necessary to systematically exercise specific code paths; and
automatically generating executable unit tests based on the identified backward conditions by utilizing a large language model (LLM) to generate forward-reasoned executable test code.

2. The method of claim 1, further comprising:
executing the generated unit tests; and
collecting code coverage information resulting from execution.

3. The method of claim 1, further comprising:
evaluating test execution results and code coverage information produced by executing the generated unit tests;
identifying runtime errors, logical errors, compilation errors, or insufficiently tested code paths based on the evaluation; and
automatically generating, using the LLM, additional targeted unit tests or suggesting adjustments to existing mock-up compilation units to enhance overall code coverage and address identified errors or coverage gaps.

4. The method of claim 3, further comprising automatically identifying and correcting unintended regressions introduced during software modification by comparing unit test outputs against previously established golden unit-test results.

5. The method of claim 3, wherein the evaluating the test execution results comprises analyzing detailed diagnostic outputs from executed unit tests indicating expected versus actual results.

6. The method of claim 1, wherein the symbolic formal verification comprises employing an Efficient SMT-Based Model Checker (ESBMC).

7. The method of claim 6, wherein the ESBMC analyzes the mock-up compilation units for runtime errors, integer overflow conditions, and boundary checking violations.

8. The method of claim 1, further comprising using cloud infrastructure to host and operate the large language model.

9. The method of claim 1, wherein the generating mock-up compilation units comprises:
consolidating functions and previously static variables from multiple original source files into a single compilation unit; and
automatically converting static variables into externally accessible global variables.

10. The method of claim 1, further comprising aggregating the generated unit test results in a database to provide unified coverage reports highlighting tested and untested code segments.

11. The method of claim 10, wherein the aggregated database of unit test results is used as a golden reference for future regression testing.

12. The method of claim 1, wherein the mock-up compilation units and unit tests are automatically regenerated upon each software code change to ensure continuous testing accuracy and regression detection.

13. The method of claim 1, wherein the symbolic verification engine explicitly generates sensitization conditions capable of triggering integer overflow and boundary conditions to systematically expose vulnerabilities.

14. The method of claim 1, further comprising performing automated real-time data extraction and integrating real-time data sources with the large language model to ensure contextually relevant test scenario generation.

15. The method of claim 1, wherein the method is executed via one or more processors configured within a Software-as-a-Service (SaaS) or cloud-based computing infrastructure.

16. An artificial intelligence (AI)-driven multi-agent software testing system for automatically generating unit tests, the AI-driven multi-agent software testing system comprising:
one or more processors; and
memory storing instructions that, when executed, cause the one or more processors to:
analyze target software code to identify implied functions, dependencies, and static variables across compilation units;
automatically generate mock-up compilation units based on the analysis by removing static restrictions to enable direct unit testing;
perform symbolic formal verification on the mock-up compilation units using a symbolic verification engine to identify backward arithmetic and logical conditions necessary to systematically exercise specific code paths; and
automatically generate executable unit tests based on the identified backward conditions by utilizing a large language model (LLM) to generate forward-reasoned executable test code.

17. The AI-driven multi-agent software testing system of claim 16, wherein the instructions that, when executed, further cause the one or more processors to:
execute the generated unit tests; and
collect code coverage information resulting from execution.

18. The AI-driven multi-agent software testing system of claim 16, wherein the instructions that, when executed, further cause the one or more processors to:
evaluate test execution results and code coverage information produced by executing the generated unit tests;
identify runtime errors, logical errors, compilation errors, or insufficiently tested code paths based on the evaluation; and
automatically generate, using the LLM, additional targeted unit tests or suggesting adjustments to existing mock-up compilation units to enhance overall code coverage and address identified errors or coverage gaps.

19. A non-transitory computer-readable medium for automatically generating unit tests in an artificial intelligence (AI)-driven multi-agent software testing system, the non-transitory computer-readable medium comprising instructions that, when executed, cause one or more processors to perform steps of:
analyzing target software code to identify implied functions, dependencies, and static variables across compilation units;
automatically generating mock-up compilation units based on the analysis by removing static restrictions to enable direct unit testing;
performing symbolic formal verification on the mock-up compilation units using a symbolic verification engine to identify backward arithmetic and logical conditions necessary to systematically exercise specific code paths; and
automatically generating executable unit tests based on the identified backward conditions by utilizing a large language model (LLM) to generate forward-reasoned executable test code.

20. The non-transitory computer-readable medium of claim 19, wherein the steps further include:
executing the generated unit tests; and
collecting code coverage information resulting from execution.
